(19) United States
(12) Patent Application Publication
(10) Pub. No.: US 2009/0278737 A1
(43) Pub. Date: Nov. 12, 2009

(54) METHOD AND SYSTEM OF TRACE-POSITION

(75) Inventor: Ming-Sung CHIU, Taipei (TW)

Correspondence Address: Muncy, Geissler, Olds & Lowe, PLLC, P.O. BOX 1364, FAIRFAX, VA, 22038-1364, US

(73) Assignee: Inventec Appliances Corp.

(21) Appl. No.: 12/341,401

(22) Filed: Dec. 22, 2008

(30) Foreign Application Priority Data
May 6, 2008 (TW) 097116704

(51) Int. Cl. G01S 1/00

(52) U.S. Cl. 342/357.09

(57) ABSTRACT

A method of trace-position including following steps is provided. A tracing message is transferred to a second electronic device having a positioning function from a first electronic device, wherein the tracing message has a verifying code. The verifying code is verified by the second electronic device. The second electronic device enables the positioning function to generate positioned information and transfer the positioned information to the first electronic device if the verifying code is correct. Furthermore, the positioning function is disabled if the verifying code is incorrect. In addition, a system of trace-position is provided.

This application claims the benefit of Taiwan Patent Application Serial No. 097116704, filed May 6, 2008, the subject matter of which is incorporated herein by reference.

### BACKGROUND OF THE INVENTION

(1) Field of the Invention

The present invention relates to a method of trace-position and a system of trace-position, and more particularly to a method of trace-position and a system of trace-position using a global positioning system (GPS).

(2) Description of the Prior Art

In recent years, the highly developed technology resulting from raising concerns on human communications have impacts on all aspects of people's daily life, the development of global positioning system (GPS) is an example of such impacts. GPS is a navigation system combining the satellites and wireless technologies and is applied to navigation positioning, precision measurements and standard time setting.

With the advancement of technologies, current mobile electronic device combining GPS technology is ready to provide navigation position function. The aforementioned mobile electronic device for example is a cell phone, a personal digital assistant (PDA) or a navigator. In addition, the positioning function of the GPS is also applicable to vehicle security devices. Typically, a vehicle security device has to connect to the operating system at the vehicle security company to transfer a message containing the positioned information of the vehicle to the vehicle security user's cell phone. As a result, the vehicle security user has to pay extra service charge to use the abovementioned message delivered to the cell phone.

### SUMMARY OF THE INVENTION

Accordingly, it is an aspect of the present invention to provide a method of trace-position and a system of trace-position to allow a user to track the position of a target directly.

The method of trace-position comprises following steps: the first step is to transfer a tracing message from the first electronic device to the second electronic device having positioning function, wherein the tracing message has a verifying code. The second electronic device receives and verifies the tracing message. The second electronic device enables the positioning function to generate the positioned information and transfers the positioned information to the first electronic device when the verifying code is correct. The second electronic device disables the positioning function when the verifying code is incorrect.

The system of trace-position comprises: a first electronic device having a first transferring module and a first receiving module, wherein the first transferring module is capable of transferring a tracing message having a verifying code; and a second electronic device having a second transferring module, a second receiving module, a password verifying module and a global positioning system module. The second receiving module is coupled to the password verifying module, the password verifying module is coupled to the global positioning system module, the global positioning system module is coupled to the second transferring module. The second receiving module is capable of receiving the tracing message, the password verifying module is capable of verifying the code. The global positioning system module is capable of generating positioned information. The second transferring module is capable of transferring the positioned information to the first electronic device. The first receiving module is capable of receiving the positioned information.

The present invention utilizes the technology to transfer data (eg text messages) between the first electronic device and the second electronic device to allow the user of the first electronic device to track the position of the user of second electronic device. Compare to prior art, the method of trace-position and the system of trace-position according to the aspect of the present invention allows a user to track the position of a target directly without third party service from a security company or other tracking service providers, such that the cost for the user on tracking position of a target is reduced.

The characteristics and benefits of the present invention will become more readily apparent to those ordinarily skilled in the art after reviewing preferred embodiments in the following detailed description and accompanying drawings.

### BRIEF DESCRIPTION OF THE DRAWINGS

The present invention will now be specified with reference to its preferred embodiment illustrated in the drawings, in which:

FIG. 1 is a block diagram of a system of trace-position according to one embodiment of the present invention; and

FIG. 2 illustrates a flow chart of a method of trace-position according to one embodiment of the present invention.

### DESCRIPTION OF THE PREFERRED EMBODIMENT

The invention disclosed herein is directed to a method and a system of trace-position. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

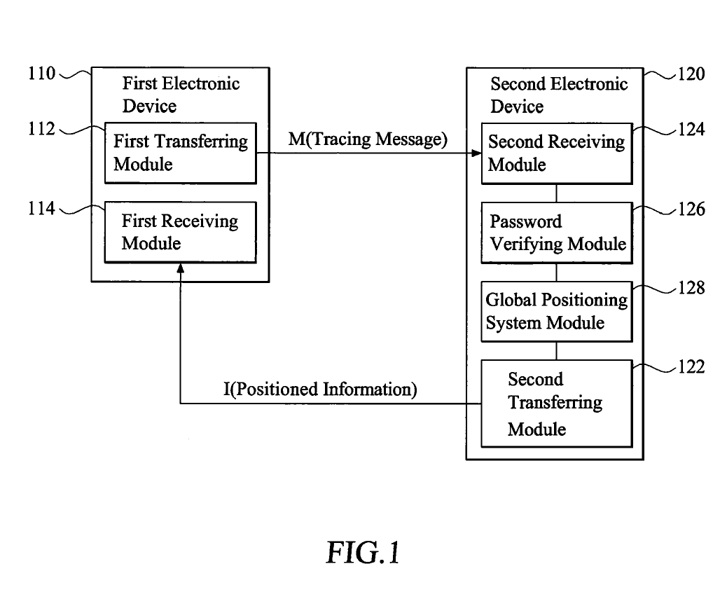

FIG. 1 is a block diagram of a system of trace-position according to an embodiment of the present invention. Referred to FIG. 1, the system of trace-position 100 comprises a first electronic device 110 and a second electronic device 120. The second electronic device 120 is capable of installing on the tracking target for example a vehicle. With the first electronic device 11, a user sends data (for example, a short message) to the second electronic device 120. In respond to the received data, the second electronic device 120 transfers the positioned information of the vehicle location back to the first electronic device 110 for user's reference. The system of trace-position 100 according to an embodiment of the present invention is detailed in the following.

According to the above, the first electronic device 110 according to the embodiment of the present invention is a mobile electronic device such as a cell phone, a PDA or a mobile notebook. The second electronic device 120 is a mobile electronic device having GPS positioning function such as a cell phone, PDA, navigator or a mobile notebook. The first electronic device 110 has a first transferring module 112 and a first receiving module 114, wherein the first transferring module 112 is capable of transferring a tracing message M having a verifying code to the second electronic device 120.

According to the embodiment of present invention, the second electronic device 120 has a second transferring module 122, a second receiving module 124, a password verifying module 126 and a global positioning system module 128. The second receiving module 124 is coupled to the password verifying module 126. The password verifying module 126 is coupled to the global positioning system module 128. The global positioning system module 128 is connected to the second transferring module 122. The second receiving module 124 is capable of receiving tracing message M. The password verifying module 126 is capable of verifying the code. The global positioning system module 128 is capable of generating positioned information I. The second transferring module 124 is capable of transferring the positioned information I back to the electronic device 110. And the first receiving module 114 is capable of receiving the positioned information I.

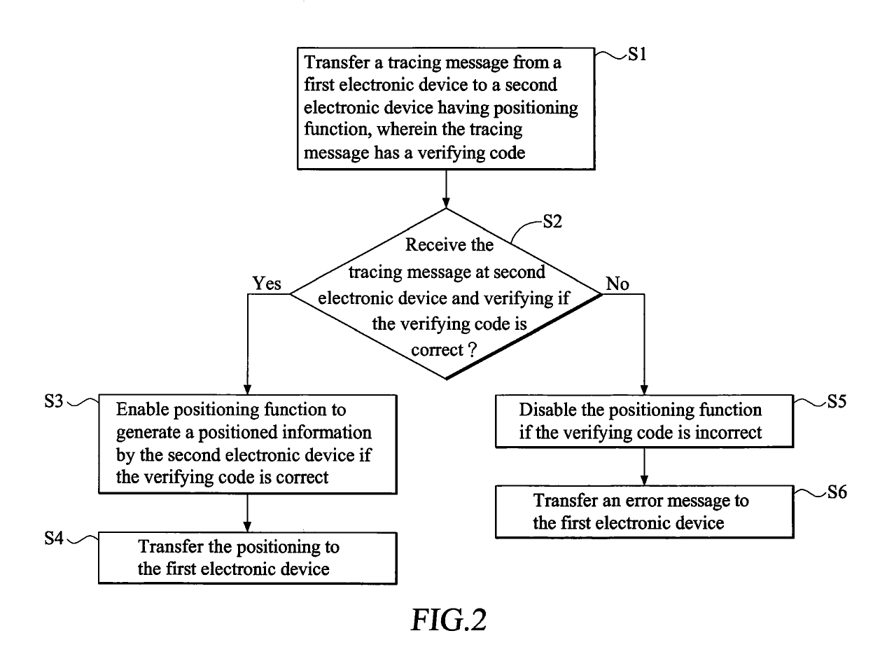

FIG. 2 illustrates a flow chart of a method of trace-position according to an embodiment of the present invention. Referred to FIG. 2, the method of trace-position according to the embodiment comprises following steps: the step SI starts with transferring a tracing message from the first electronic device to the second electronic device having positioning function, wherein tracing message has a verifying code. In the embodiment, the first transferring module 112 transfers the tracing message as shown in the FIG. 1. The tracing message for example is a short message service (SMS) or a multimedia message service (MMS) and the verifying code for example contains words, numbers and symbols. Alternatively, in other embodiments according to the present invention, the verifying code is selected from at least two components of the group consisting of words, numbers and symbols. However, the scope of the invention is not limited thereto.

Upon the first electronic device transferring the tracing message to the second electronic device, at the S2, the second electronic device receives the tracing message, and verifies the verifying code. As shown in the FIG. 1, the second receiving module of the second electronic device receives the tracing message. The password verifying module coupled to the second receiving module then verifies whether the verifying code is correct or not. If verifying code is correct, the method moves to step S3. At step S3, the second electronic device enables the positioning function to generate positioned information. Specifically, if the verifying code is correct, the password verifying module initiates the global positioning system module as shown in FIG. 1 to execute the positioning function. The global positioning system module receives the positioning signals from the satellites system and generates the positioned information indicating the location of the second electronic device.

Followed by generating the positioned information indicating the location of the second electronic device, at step S4, the second electronic device transfers the positioned information back to the first electronic device, wherein the aforementioned positioned information for example contains coordinates, images or descriptive words. Thus, the user of the first electronic device becomes aware of the location of the target having the second electronic device via the positioned information. It should be noted that, the embodiment is limited to that the second electronic device is an electronic device having the positioning function, such limitation is not applicable to the first electronic device. The first electronic device according to the present invention is a cell phone, PDA or a mobile notebook. In addition, the first electronic device also can be a desktop computer, and the tracing message is transferred to the second electronic device via a network.

Moreover, for example, the aforementioned second electronic device is installed in a vehicle; the second electronic device can also be installed in an elderly or a child to allow family members to quickly and easily track the location of the elderly or the child. In particular, a user is allowed to track the location of a target via aforementioned method of trace-position without third party service from a security company or other tracking service providers.

Referred to FIG. 2, if the verifying code is incorrect, the method moves to step S5, the second electronic device disables positioning function. Typically, it is possible that a user of the first electronic device may transfer a tracing message having an incorrect verifying code. To address the possibility, for example, in the present embodiment, the second electronics device transfers an error message back to the first electronic device (as shown in step S6) upon disabling the positioning function. Such that the user of the first electronic device can transfer a tracing message having correct verifying code upon receiving the error message to continue the process to track the location of the target.

In conclusion, the method of trace-position and the system of trace-position according to the aspect of the present invention are implemented by directly transferring a tracing message having verifying code from first electronic device, where the first electronic device is capable of user operation, and the second electronic device is installed in the tracking target of the use, capable of verifying the verifying code. The positioning function is performed by generating the positioned information at the aforementioned second electronic device when the verifying code is correct. The second electronic device transfers the positioned information back to the first electronic device to allow the user of the first electronic device to become aware of location of the tracking target installed with a second electronic device.

Compare to prior art, the method of trace-position and the system of trace-position according to the present invention allows a user to track the position of a target directly without third party service from a security company or other tracking service providers, such that the cost for the user on tracking position of a target is reduced.

While the present invention has been particularly shown and described with reference to a preferred embodiment, it will be understood by those skilled in the art that various changes in form and detail may be without departing from the spirit and scope of the present invention.

I claim:

1. A method of trace-position comprising:
transferring a tracing message from a first electronic device to a second electronic device having positioning function, wherein said tracing message has a verifying code;
receiving and verifying said tracing message at said second electronic device;
enabling positioning function to generate said positioned information by said second electronic device when said verifying code is correct; and
transferring said positioned information to said first electronic device.

2. The method of trace-position of claim 1, wherein disabling said positioning function when said verifying code is incorrect.

3. The method of trace-position of claim 1, wherein disabled positioning function further comprises a step of transferring an error message to said first electronic device.

4. The method of trace-position of claim 1, wherein said tracing message is a short message service (SMS) or a multimedia message service (MMS).

5. The method of trace-position of claim 1, wherein said verifying code comprises words, numbers or symbols.

6. The method of trace-position of claim 1, wherein said verifying code is selected from at least two components of the group consisting of words, numbers and symbols.

7. The method of trace-position of claim 1, wherein said positioned information comprises coordinates.

8. The method of trace-position of claim 1, wherein said positioned information comprises images.

9. The method of trace-position of claim 1, wherein said positioned information comprises descriptive words.

10. The method of trace-position of claim 1, wherein said first electronic device comprises mobile electronic device.

11. The method of trace-position of claim 1, wherein said second electronic device comprises mobile electronic device.

12. A system of trace-position comprises:
a first electronic device having a first transferring module and a first receiving module, wherein said first transferring module is capable of transferring a tracing message having a verifying code; and
a second electronic device having a second transferring module, a second receiving module, a password verifying module and a global positioning system module, wherein said second receiving module is coupled to said password verifying module, said password verifying module is coupled to said global positioning system module, said global positioning system module is coupled to said second transferring module, and wherein said second receiving module is capable of receiving said tracing message, said password verifying module is capable of verifying said verifying code, said global positioning system module is capable of generating positioned information, said second transferring module is capable of transferring said positioned information to said first electronic device, and said first receiving module is capable of receiving said positioned information.

13. The system of trace-position of claim 12, wherein said tracing message is short message service (SMS) or multi message service (MMS).

14. The system of trace-position of claim 12, wherein said verifying code comprises words, numbers or symbols.

15. The system of trace-position of claim 12, wherein said verifying code is selected from at least two components of the group consisting of words, numbers and symbols.

16. The system of trace-position of claim 12, wherein said positioned information comprises coordinates or images.

17. The system of trace-position of claim 12, wherein said positioned information comprises descriptive words.

18. The system of trace-position of claim 12, wherein said first electronic device comprises mobile electronic device.

19. The system of trace-position of claim 12, wherein said second electronic device comprises mobile electronic device
